(19) United States
(12) Patent Application Publication
(10) Pub. No.: US 2013/0153680 A1
(43) Pub. Date: Jun. 20, 2013

(54) FLUID INJECTOR HAVING HEATER

(71) Applicants: Sridhar Thangaswamy, Peoria, IL (US); Thomas R. McClure, Washington, IL (US)

(72) Inventors: Sridhar Thangaswamy, Peoria, IL (US); Thomas R. McClure, Washington, IL (US)

(73) Assignee: CATERPILLAR INC., Peoria, IL (US)

(21) Appl. No.: 13/328,576

(22) Filed: Dec. 16, 2011

(51) Int. Cl. B05B 1/24

(52) U.S. Cl. 239/135

(57) ABSTRACT

A fluid injector unit for use in an exhaust treatment system includes; a fluid injector having a fluid receiving end and a fluid injecting end, a heater disposed about the fluid injecting end of the fluid injector, and an electrical contact member electrically connected to the heater, wherein the electrical contact member includes; an electrical contact pin electrically coupled to the heater, and a ceramic end seal axially surrounding the electrical contact pin.

### TECHNICAL FIELD

The present disclosure is directed to a fluid injector and, more particularly, to a fluid injector having a heater.

### BACKGROUND

Engines, including diesel engines, gasoline engines, gaseous fuel powered engines, and other engines known in the art exhaust a complex mixture of emissions. These emissions include particulate matter commonly referred to as soot. Exhaust emission standards and regulations have become more stringent and the amount of particulate matter emitted from an engine is regulated depending on the type of engine, size of engine, and/or class of engine.

One method implemented by engine manufacturers to comply with the regulation of particulate matter exhausted to the environment has been to remove the particulate matter from the exhaust flow of an engine with a device called a particulate trap or diesel particulate filter (DPF). A particulate trap is a filter designed to trap particulate matter and typically consists of a wire mesh or ceramic honeycomb medium. However, the use of the particulate trap for extended periods of time may cause the particulate matter to build up in the medium, thereby reducing the functionality of the filter and subsequent engine performance.

There is a plurality of methods for removing particulate matter from the medium. In one method, the collected particulate matter may be removed from the filter through a process called regeneration. To initiate regeneration of the filter, the temperature of the particulate matter trapped within the filter is elevated to a combustion threshold of the particulate matter, i.e., a temperature at which the particulate matter is combusted. One way to elevate the temperature of the particulate matter is to inject a catalyst such as diesel fuel into the exhaust flow of the engine and ignite the injected fuel. Alternatively, the catalyst may be injected into the exhaust stream to be deposited on the particulate matter on the medium, at which point an exothermic reaction may take place on the medium itself.

After the regeneration event, the supply of fuel is shut off. However, some fuel may remain within the fuel injector or the fuel lines that direct fuel to the injector. This remaining fuel, when subjected to the harsh conditions of the exhaust stream may coke or be partially burned, leaving behind a solid residue that can restrict or even block the fuel injector. In addition, it may be possible for particulate matter from the exhaust flow to enter and block the injector. For this reason, it may be beneficial to periodically purge the injector of fuel and/or any built up residue or particulate matter between regeneration events.

One method of purging a fuel injector is described in U.S. Pat. No. 4,987,738 (the '738 patent) issued to Lopez-Crevillen et al. on Jan. 29, 1991. Specifically, the '738 patent discloses a particulate filter having a burner used to combust trapped particulates. The burner includes a fuel injector nozzle for injecting fuel into the burner during regeneration. As illustrated in FIG. 1 of the '738 patent, a fuel pump supplies fuel to the injector nozzle via a passageway axially aligned with a bore of the nozzle. In order to maintain efficient and reliable operation of the burner, a supply of purge air is directed through the axially aligned passageway to the fuel injector nozzle following a regeneration event to purge the nozzle of fuel. Purge air continues to flow through the injector nozzle until a subsequent regeneration event.

Although the burner of the '738 patent may benefit somewhat from the purging process described above, the gain may be expensive. In particular, the additional passageways required to support the air purging may increase machining cost, component cost, and assembly time. And, the continuous flow of purge air may be expensive to maintain and increase the risk of debris fowling the fluid injector nozzle.

The fluid injector of the present disclosure solves one or more of the problems set forth above.

### SUMMARY

A fluid injector unit for use in an exhaust treatment system includes; a fluid injector having a fluid receiving end and a fluid injecting end, a heater disposed about the fluid injecting end of the fluid injector, and an electrical contact member electrically connected to the heater, wherein the electrical contact member includes; an electrical contact pin electrically coupled to the heater, and a ceramic end seal axially surrounding the electrical contact pin.

Other features and aspects of this disclosure will be apparent from the following description and the accompanying drawings.

### BRIEF DESCRIPTION OF THE DRAWINGS

FIG. 1 is a schematic and diagrammatic illustration of an exemplary disclosed power unit;

FIG. 2 is an exploded view illustration of an exemplary disclosed exhaust treatment device for use with the power unit of FIG. 1;

FIG. 3 is a cross-sectional illustration of the exhaust treatment device of FIG. 2;

FIG. 4 is a cross-sectional illustration of a fluid injector unit of the exhaust treatment device of FIGS. 2 and 3;

FIG. 5 is a magnified view of the area within the dashed-line box of FIG. 4;

FIG. 6 is a cross-sectional illustration of the end cap of the fluid injector unit of the disclosed exhaust treatment device;

FIG. 7 is an isometric view of an end cap of the fluid injector unit of the disclosed exhaust treatment device; and

FIG. 8 is a cross-sectional illustration of an exhaust aftertreatment device with the end-cap removed and a female electrical connection installed.

### DETAILED DESCRIPTION

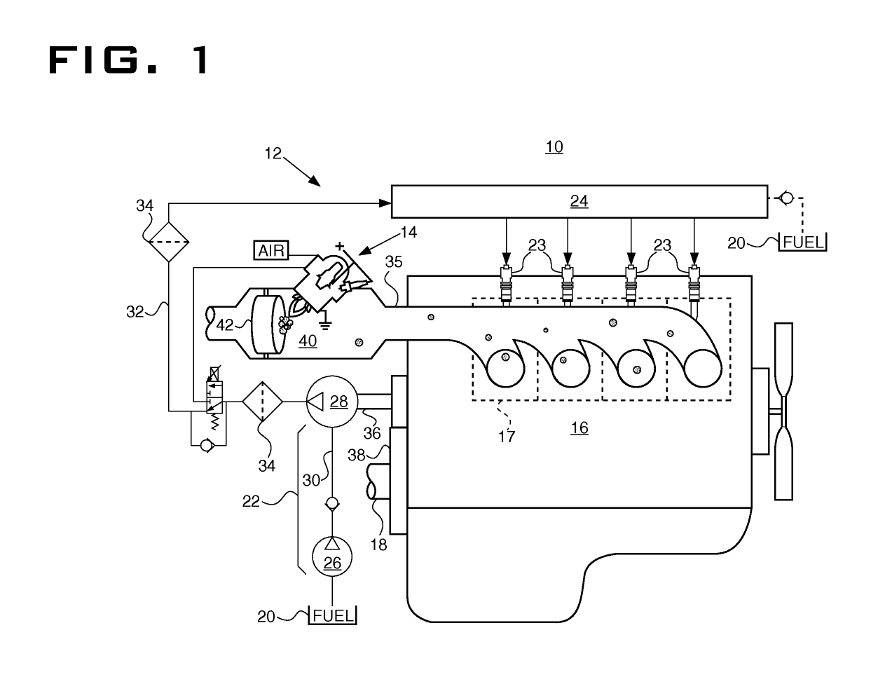

FIG. 1 illustrates a power unit 10 having a fuel system 12 and an auxiliary regeneration system 14. For the purposes of this disclosure, power unit 10 is depicted and described as a four-stroke diesel engine. One skilled in the art will recognize, however, that power unit 10 may be any other type of internal combustion engine such as, for example, a gasoline or a gaseous fuel-powered engine. Power unit 10 may include an engine block 16 that at least partially defines a plurality of combustion chambers 17. In the illustrated embodiment, power unit 10 includes four combustion chambers 17. However, it is contemplated that power unit 10 may include a greater or lesser number of combustion chambers 17 and that combustion chambers 17 may be disposed in an “in-line” configuration, a “V” configuration, a rotary configuration, or any other suitable configuration.

As also shown in FIG. 1, power unit 10 may include a crankshaft 18 that is rotatably disposed within engine block 16. A connecting rod (not shown) may connect at least one of a plurality of pistons (not shown) to crankshaft 18 so that a sliding motion of each piston within the respective combustion chamber 17 results in a rotation of crankshaft 18. Similarly, a rotation of crankshaft 18 may result in a sliding motion of the pistons.

Fuel system 12 may include components that cooperate to deliver injections of pressurized fuel into each of combustion chambers 17. Specifically, fuel system 12 may be a common rail system and include a tank 20 configured to hold a supply of fuel, and a fuel pumping arrangement 22 configured to pressurize the fuel and direct the pressurized fuel to a plurality of fuel injectors 23 by way of a common rail 24.

Fuel pumping arrangement 22 may include one or more pumping devices that function to increase the pressure of the fuel and direct one or more pressurized streams of fuel to common rail 24. In one example, fuel pumping arrangement 22 includes a low pressure source 26 and a high pressure source 28 disposed in series and fluidly connected by way of a fuel line 30. Low pressure source 26 may embody a transfer pump that provides low pressure feed to high pressure source 28. High pressure source 28 may receive the low pressure feed and increase the pressure of the fuel to as much as 300 MPa in some cases. High pressure source 28 may be connected to common rail 24 by way of a fuel line 32. One or more filtering elements 34, such as a primary filter and a secondary filter, may be disposed in fluid communication with fuel line 32 in series relation to remove debris and/or water from the fuel pressurized by fuel pumping arrangement 22.

In one embodiment, one or both of low and high pressure sources 26, 28 may be operatively connected to power unit 10 and driven by crankshaft 18. Low and/or high pressure sources 26, 28 may be connected with crankshaft 18 in any manner readily apparent to one skilled in the art where a rotation of crankshaft 18 will result in a corresponding driving rotation of a pump shaft. For example, a pump driveshaft 36 of high pressure source 28 is shown in FIG. 1 as being connected to crankshaft 18 through a gear train 38. It is contemplated, however, that one or both of low and high pressure sources 26, 28 may alternatively be driven electrically, hydraulically, pneumatically, or in any other appropriate manner. It is further contemplated that fuel system 12 may alternatively embody another type of fuel system such as, for example, a mechanical unit fuel injector system or a hydraulic unit fuel injector system where the pressure of the injected fuel is generated or enhanced within individual injectors without the use of the high pressure source 28 or the common rail 24.

Auxiliary regeneration system 14 may be associated with an exhaust treatment device 40. In particular, exhaust from power unit 10 may be communicated via exhaust passageway 35 to an end portion of exhaust passageway 35 (not shown), where the exhaust may be released into the atmosphere. Prior to reaching the end portion of exhaust passageway 35, the exhaust may pass through exhaust treatment device 40. In exhaust treatment device 40, exhaust constituents, such as particulate matter, gaseous oxides of nitrogen (NOx), unburnt hydrocarbons (HC), and other constituents, may be removed from the exhaust flow or otherwise converted to innocuous gases. In one example, exhaust treatment device 40 may include a wire mesh or ceramic honeycomb filtration medium 42 situated to remove particulate matter from the exhaust flow. Over time, the particulate matter may build up in filtration medium 42 and, if left unchecked, the particulate matter buildup could be significant enough to restrict or even block the flow of exhaust through exhaust treatment device 40, allowing backpres sure within power unit 10 to increase. An increase in the backpressure of power unit 10 could reduce the power unit's ability to draw in fresh air, resulting in decreased performance, increased exhaust temperatures, and increased fuel consumption.

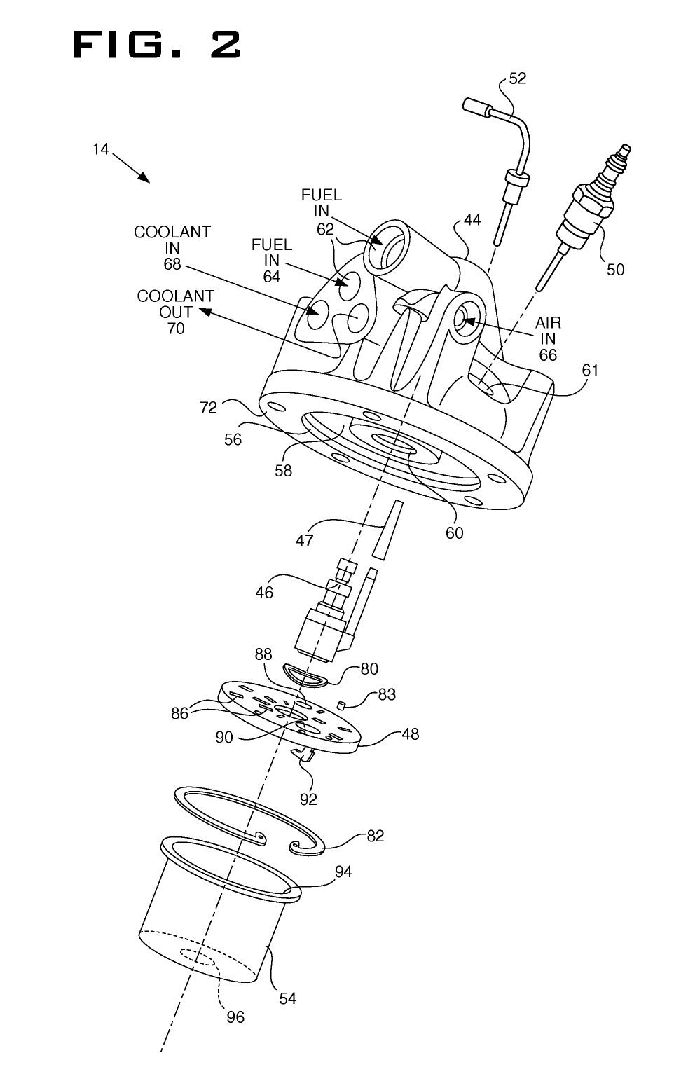

As illustrated in FIG. 2, auxiliary regeneration system 14 may include components that cooperate to periodically reduce the buildup of particulate matter within exhaust treatment device 40. These components may include, among other things, a housing 44, a fluid injector unit 46, a mixing plate 48, a spark plug 50, a thermocouple 52, and a combustion canister 54. It is contemplated that auxiliary regeneration system 14 may include additional or different components, such as, for example, one or more pilot injectors, additional main injectors, a controller, a pressure sensor, a flow sensor, a flow blocking device, and other components known in the art. In addition, it is contemplated that auxiliary regeneration system 14 may omit one or more components listed above. It is further contemplated that instead of, or in addition to, filtration medium 42 (see FIG. 1), exhaust treatment device 40 may include a Selective Catalytic Reduction (SCR) device and an associated injector (not shown) similar to fluid injector unit 46 for introducing a reductant such as, for example, urea into the exhaust flow upstream of the SCR device.

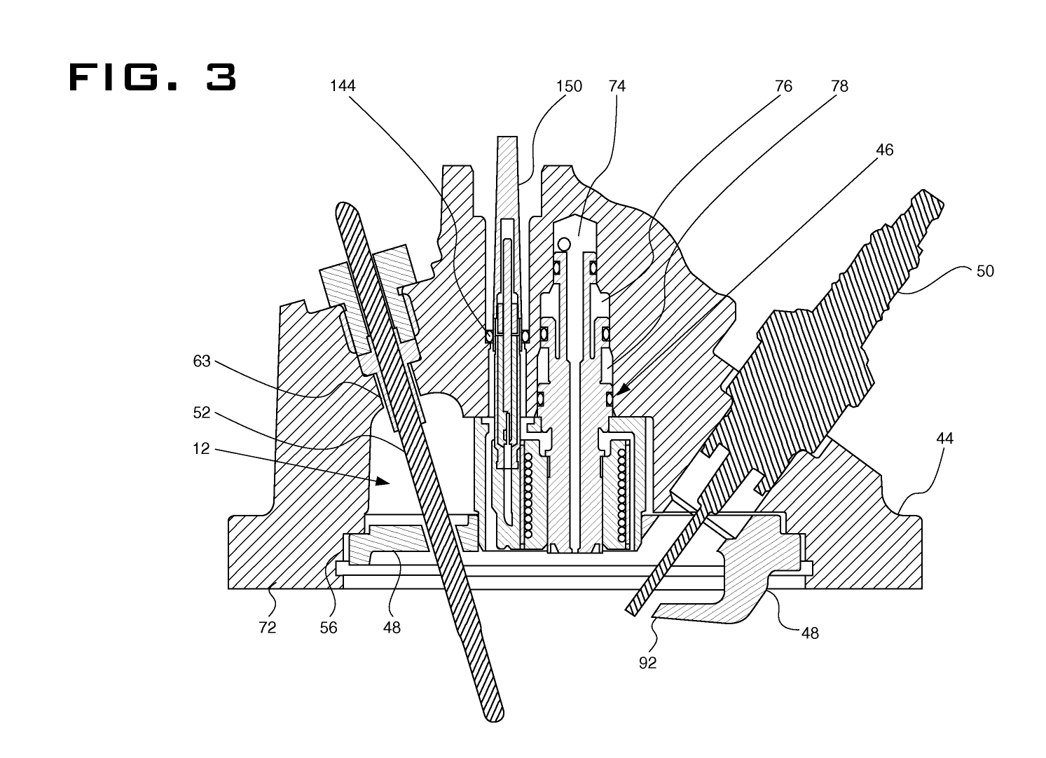

Housing 44 may receive and fluidly interconnect fluid injector unit 46, mixing plate 48, spark plug 50, and thermocouple 52. In particular, housing 44 may have a central stepped bore 56, an annular recessed opening 58, a centrally located bore 60, a first radially offset bore 61, and a second radially offset bore 63 (illustrated in FIG. 3). Housing 44 may also include a pilot fuel passage 62, a main fuel passage 64, an air supply passage 66, and inlet and outlet cooling passages 68 and 70, respectively. One or more check valves (not shown) may be situated in any one or all of these passages, if desired, to ensure unidirectional flow of the respective fluids within the passages and/or to reduce or minimize the volumes thereof that could require periodic re-supplying or purging.

Centrally located bore 60 may receive fluid injector unit 46 and end cap 47 through an inner surface 72 (referring to the surface of housing 44 illustrated in FIG. 2 as being open to combustion canister 54). Centrally located bore 60, together with fluid injector unit 46 may form a pilot fuel chamber 74 (referring to FIG. 3), a main fuel chamber 76, and a coolant chamber 78 within the steps of centrally located bore 60. Pilot fuel chamber 74 may be fluidly communicated with pilot fuel passage 62, while main fuel chamber 76 may be fluidly communicated with main fuel passage 64. Coolant chamber 78 may be fluidly communicated with both the inlet and outlet cooling passages 68, 70. Mixing plate 48 may retain fluid injector unit 46 within centrally located bore 60 by way of a resilient member such as a Bellville washer 80. End cap 47 may protect elements of fluid injector unit 46 during shipping and assembly as discussed in more detail below. Alternative embodiments may include additional elements, or omit listed elements as appropriate.

Central stepped bore 56 may receive mixing plate 48 also through inner surface 72. Mixing plate 48 may be press-fit completely within central stepped bore 56 and/or held in place with a snap ring 82. Mixing plate 48 may be centrally aligned with fluid injector unit 46 and housing 44, and angularly oriented with respect to housing 44 by way of one or more dowel pins 83.

First radially offset bore 61 may receive spark plug 50 through an external surface of housing 44. In particular, spark plug 50 may include external threads (not shown) that engage internal threads (not shown) of first radially offset bore 61. First radially offset bore 61 may be in communication with air supply passage 66, if desired, such that carbon and other contaminates may be periodically purged from first radially offset bore 61 and, thereby, prevented from building on spark plug 50 and causing unintentional arcing thereof.

The second radially offset bore 63 may receive thermocouple 52 through the external surface of housing 44. Similar to spark plug 50, thermocouple 52 may also have external threads (not shown) that engage internal threads (not shown) of the second radially located bore. Although no passages are illustrated as communicating fluids with thermocouple 52, it is contemplated that purge fluid such as air from air supply passage 66 may alternatively, or additionally, be directed to the second radially offset bore 63 to reduce or minimize the buildup of contaminates therein, if desired.

Fluid injector unit 46 may be disposed within housing 44 and operable to inject one or more amounts of pressurized fuel (e.g., such as through pilot, main, and/or post injections) into combustion canister 54 at predetermined timings, fuel pressures, and fuel flow rates. The timing of fuel injection into combustion canister 54 may be synchronized with sensory input received from thermocouple 52, one or more pressure sensors (not shown), a timer (not shown), a radio frequency sensor (not shown) or any other similar sensory devices such that the injections of fuel substantially correspond with a buildup of particulate matter within filtration medium 42 (referring to FIG. 1). For example, fuel may be injected as the temperature of the exhaust flowing through exhaust treatment device 40 exceeds a predetermined value. Alternatively or additionally, fuel may be injected as a pressure of the exhaust flowing through exhaust treatment device 40 exceeds a predetermined pressure level or a pressure drop across filtration medium 42 exceeds a predetermined differential value. It is contemplated that fuel may also be injected on a set periodic basis, in addition to or regardless of pressure and temperature conditions, if desired.

Mixing plate 48 (e.g., a swirl plate), together with annular recessed opening 58 of housing 44, may form an air distribution passage 84 (referring to FIG. 3), which may be supplied with compressed air via air supply passage 66. Mixing plate 48 may include a plurality of annularly disposed air vents 86 fluidly communicating air distribution passage 84 with combustion canister 54. Air vents 86 may mix air with injections of fuel inside combustion canister 54 to improve combustion therein. It is contemplated that air vents 86 may additionally or alternatively direct pressurized air to the outer periphery of combustion canister 54 for cooling and/or insulating purposes, if desired. Alternative embodiments include configurations wherein the mixing plate 48 has different shapes or is omitted altogether.

Mixing plate 48 may include openings to accommodate thermocouple 52 and spark plug 50. Specifically, thermocouple 52 may extend into combustion canister 54 via a first through hole 88 in mixing plate 48, while spark plug 50 may extend into combustion canister 54 via a second through hole 90. A grounded electrode 92 may extend from mixing plate 48 proximal second through hole 90 to interact with spark plug 50.

Spark plug 50 may facilitate ignition of fuel sprayed from fluid injector unit 46 into combustion canister 54. Specifically, during a regeneration event or when a catalyst within exhaust treatment device 40 requires an elevated temperature, the temperature of the exhaust exiting power unit 10 may be too low to cause auto-ignition of the fuel sprayed from fluid injector unit 46. To initiate combustion of the fuel and, subsequently, the trapped particulate matter, a small quantity (i.e., a pilot shot) of fuel from fluid injector unit 46 may be sprayed or otherwise injected toward spark plug 50 to create a locally fuel rich atmosphere readily ignitable by spark plug 50. A spark developed between an electrode of spark plug 50 and grounded electrode 92 of mixing plate 48 may ignite the fuel in the locally fuel rich atmosphere creating a flame, which may be jetted or otherwise advanced toward the trapped particulate matter. The flame jet propagating from fluid injector unit 46 may raise the temperature within exhaust treatment device 40 to a level that readily supports efficient ignition of a larger quantity (i.e., a main shot) of fuel from fluid injector unit 46. As the main injection of fuel ignites, the temperature within exhaust treatment device 40 may continue to rise to a level that causes combustion of the particulate matter trapped within filtration medium 42 and/or to a level that supports efficient operation of a catalyst.

Thermocouple 52 may confirm successful ignition of the fuel/air mixture within combustion canister 54 and help to control an injection quantity of fuel based on an achieved temperature. A thermocouple generally includes two dissimilar metals, often embodied in slender members such as wires or rods. The two metals of the thermocouple may be joined at a measuring end of the thermocouple (usually the terminal end) via a soldered junction. When the temperature at the measuring end of the thermocouple changes relative to the temperature at a reference end (i.e., non-measuring end), a measurable voltage may be generated. The value of the measured voltage may be used to determine a temperature at the measuring end of the thermocouple. Thermocouple 52 may extend through mixing plate 48 into combustion canister 54 for indicating the temperature therein. When a temperature measured within combustion canister 54 exceeds a predetermined value, it can be concluded that ignition of the air-fuel mixture has been achieved. Similarly, when the temperature measured within combustion canister 54 drops below the predetermined value, it can be concluded that the flame jet has been extinguished. It is contemplated that the injections of fuel into combustion canister 54, the flow rate or pressure of air directed into combustion canister 54, a temperature of fluid injector unit 46, and/or other temperature dependent operations may be varied in response to the value of the current generated by thermocouple 52. While a thermocouple 52 has been described, alternative embodiments may include different temperature sensor mechanisms as appropriate.

Combustion canister 54 (referring to FIG. 2) may embody a tubular member configured to axially direct an ignited fuel/air mixture (i.e., the flame jet) from auxiliary regeneration system 14 into the exhaust flow of exhaust treatment device 40. In particular, combustion canister 54 may include a central opening 94 that fluidly communicates fuel from fluid injector unit 46 and air from air distribution passage 84 with the exhaust (i.e., central opening 94 may fluidly communicate with or be coextensive with exhaust passageway 35). Combustion canister 54 may employ a flame stabilizing plate 96 at one end of central opening 94 to provide a restriction that reduces or minimizes pulsations within exhaust treatment device 40. That is, the inner diameter of flame stabilizing plate 96 may be less than the inner diameter of central opening 94. Combustion canister 54 may be generally straight and have a predetermined length set during manufacture according to a desired flame introduction location (the distance that a flame resulting from the ignition of the fuel/air mixture extends from combustion canister 54 into the exhaust flow). In one example, this desired introduction location may be about 12 inches from flame stabilizing plate 96 of combustion canister 54.

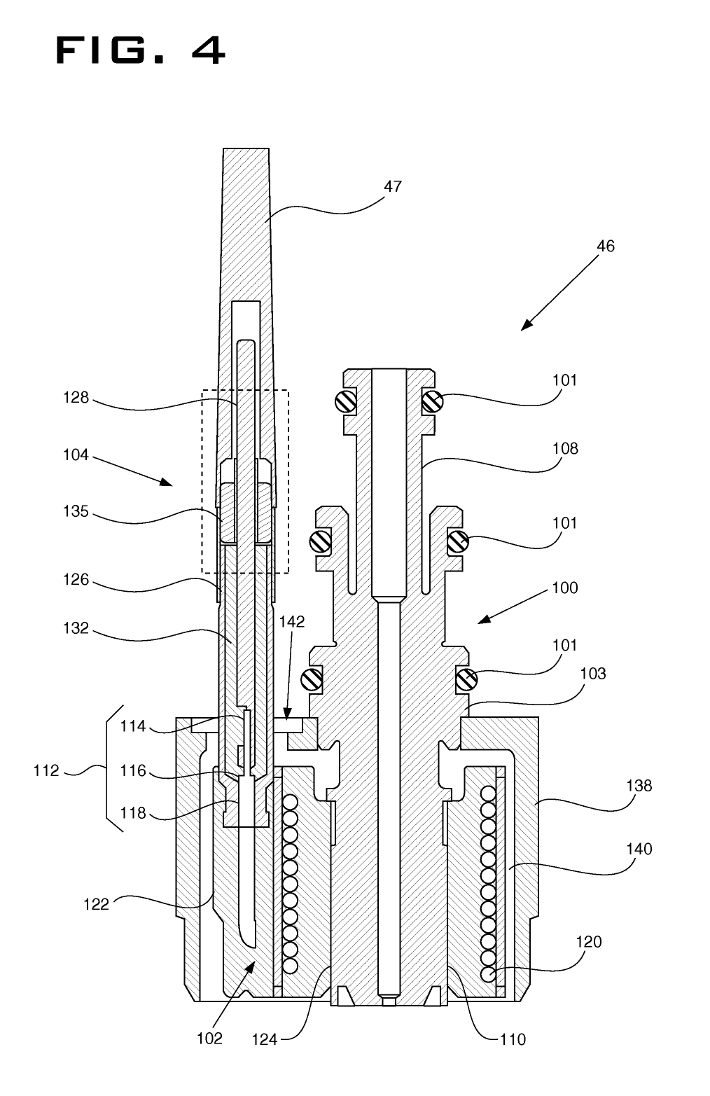

As illustrated in FIGS. 3 and 4, fluid injector unit 46 may be an assembly of multiple components that interact to ensure continued injections of fuel into combustion canister 54 (referring to FIG. 2), even under harsh operating conditions. Specifically, fluid injector unit 46 may include a fluid injector 100 that injects the fuel into the exhaust stream, a heater 102 disposed about the fluid injector 100 and an electrical contact member 104 electrically connected to the heater 102. In one embodiment, the electrical contact member 104 is sealed to protect interior components from the harsh operating environment, and the mechanism used to seal the electrical contact member 104 is ruggedized against temperature fluctuations and chemical exposure as will be discussed in more detail below. In addition, the electrical contact member 104 may be protected during shipping and assembly of the auxiliary regeneration system 14; the end cap 47 may perform this function as will also be discussed in more detail below. The various components of the fluid injector unit 46 may be press-fit or otherwise coupled together.

The fluid injector 100 may include a fluid receiving end 108 fluidly coupled to pilot fuel chamber 74 and thermally coupled to main fuel chamber 76 and coolant chamber 78. The fluid injector 100 may also include a fluid injecting end 110 which is substantially surrounded by the heater 102. The fluid injector 100 may have external surfaces of enlarged diameters at opposing ends such that recesses are created therebetween. These recess may at least partially define main fuel chamber 76 and coolant chamber 78 (referring to FIG. 3). That is, coolant from inlet cooling passage 68 may be directly in contact with the external annular surface of the fluid injector 100 at the coolant chamber 78. One or more sealing members 101, such as O-rings, may be associated with the enlarged areas of fluid injector 100 to reduce or minimize fluid leakage and contamination between the fluid injector 100 and housing 44. A flange 103 may help to correctly position the fluid injector 100 within centrally located bore 60.

The heater 102 may include a coaxial wiring 112 including an electrically conductive inner core 114, an electrically insulating sheath 116 surrounding the conductive inner core and a conductive outer sheath 118 surrounding the electrically insulating sheath 116. The coaxial wiring 112 may form at least one heater coil 120 disposed around the fluid injecting end 110 of the fluid injector 100. However, alternative embodiments include alternative wiring configurations, such as an embodiment wherein the heater 102 includes a single layered wiring, e.g., a material with a high electrical resistance connected to ground at one terminal thereof, an embodiment wherein an additional layer of insulation is added to the conductive outer sheath 118, etc.

The coaxial wiring 112 may be press-fit onto a body 122. In order to generate a flow of current through heater 102, the housing 44, mixing plate 48, Bellville washer 80, and sleeve 126 may be grounded. With the intention of minimizing the likelihood of short-circuiting between the electrically conductive inner core 114 and housing 44, the electrically conductive inner core 114 may be insulated from housing 44, e.g., via the electrically insulating sheath 116. Coaxial wiring 112 may extend from the at least one heater coil 120 in a vertical direction substantially parallel with an axial direction of the fluid injector 100 such that the effects of gravity and vibration on the coaxial wiring 112 may be reduced or minimized. It is contemplated that coaxial wiring 112 may, alternatively, extend from the at least one heater coil 120 in a horizontal or other direction, if desired.

Body 122 may embody a generally tubular member fixedly connecting the fluid injecting end 110 of the fluid injector 100 to the heater 102. That is, body 122 may include a central bore 124 that engages an outer annular surface of the fluid injecting end 110 over which heater 102 may be press fit, wire wrapped, brazed, cast, tight clearance fit, or clamped on. Body 122 may also engage the electrical contact member 104. The engagement between body 122, fluid injecting end 110 of the fluid injector 100, and heater 102 may facilitate the conductive transfer of heat from heater 102 to the fluid injecting end 110. In one embodiment, the body 122 may be made of bronze or other material with similar characteristics.

The electrical contact member 104 is electrically connected to the coaxial wiring 112 and provides a path for electrical connection between the heater 102 and an external power supply (not shown), such as an alternator or battery of power unit 10. The electrical contact member 104 is generally cylindrical in shape and includes a sleeve 126 coupled to the electrically conductive outer sheath 118 of the coaxial wiring 112 and the body 122. The sleeve 126 partially encloses an electrical contact pin 128 disposed axially therewithin. The electrical contact pin 128 protrudes from the sleeve 126 at a distal end from the heater 102 for connection with a female-type receptacle 130 as will be described in more detail with respect to FIG. 8. The electrical contact pin 128 is electrically connected with the electrically conductive inner core 114 of the coaxial wiring 112. The electrical contact member 104 also includes a thermally and electrically insulative layer 132 disposed between the sleeve 126 and the electrical contact pin 128. The electrically insulative layer 132 prevents shorting between the electrical contact pin 128 and the housing 44, which is grounded. The sleeve 126 includes a tapered shoulder region which connects with a sealing member 134.

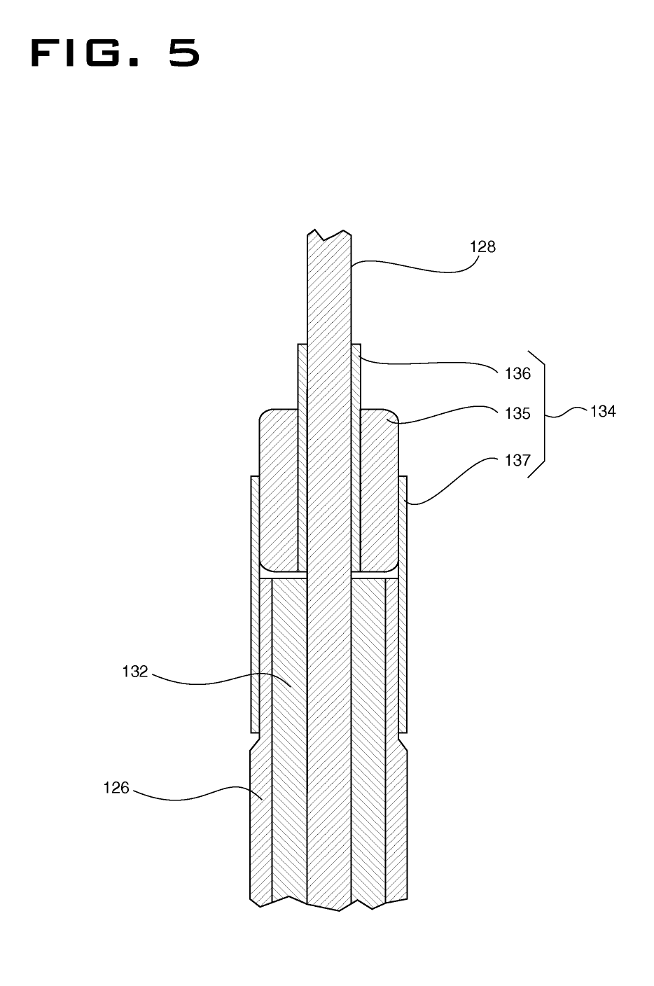

FIG. 5 is a magnified view of the area within the dashed-line box of FIG. 4. For clarity, the end cap 47 is omitted from the magnified view of FIG. 5. The sealing member 134 includes a ceramic end seal 135, an inner tube 136 and an outer tube 137. The ceramic end seal 135 axially surrounds the electrical contact pin 128. In one embodiment, the ceramic end seal 135 includes high temperature co-fired ceramic (HTCC) materials, e.g., the ceramic end seal 135 may consist of multiple layers of alumina oxide with tungsten and molymanganese metalization. The inner tube 136 is disposed between the electrical contact pin 128 and the ceramic end seal 135. The outer tube 137 is disposed axially surrounding the ceramic end seal 135. In one embodiment, the inner tube 136 and outer tube 137 are metallic. In a further embodiment, the inner tube 136 and outer tube 137 include an austenitic nickel-chromium-based alloy, such as Inconell® from Special Metals Corporation.

In one embodiment, the inner tube 136 is coupled to the ceramic end seal 135 by a first ceramic to metal braze. Similarly, in one embodiment, the outer tube 137 is coupled to the ceramic end seal 135 via a second ceramic to metal braze. However, alternative embodiments include configurations wherein alternative methods of bonding the inner tube 136 and outer tube 137 to the ceramic end seal 135 may be employed, e.g., adhesives. The outer tube 137 is coupled to the sleeve 126 distal to the heater 102. In one embodiment, the outer tube 137 may be coupled to the sleeve 126 via a laser weld. Laser welds provide for a precisely applied narrow, deep weld of high quality. However, alternative embodiments may include alternative methods of bonding the sleeve 126 to the outer tube 137. The sealing member 134 helps to prevent contamination of the electrically insulative layer 132 as will be discussed in more detail below.

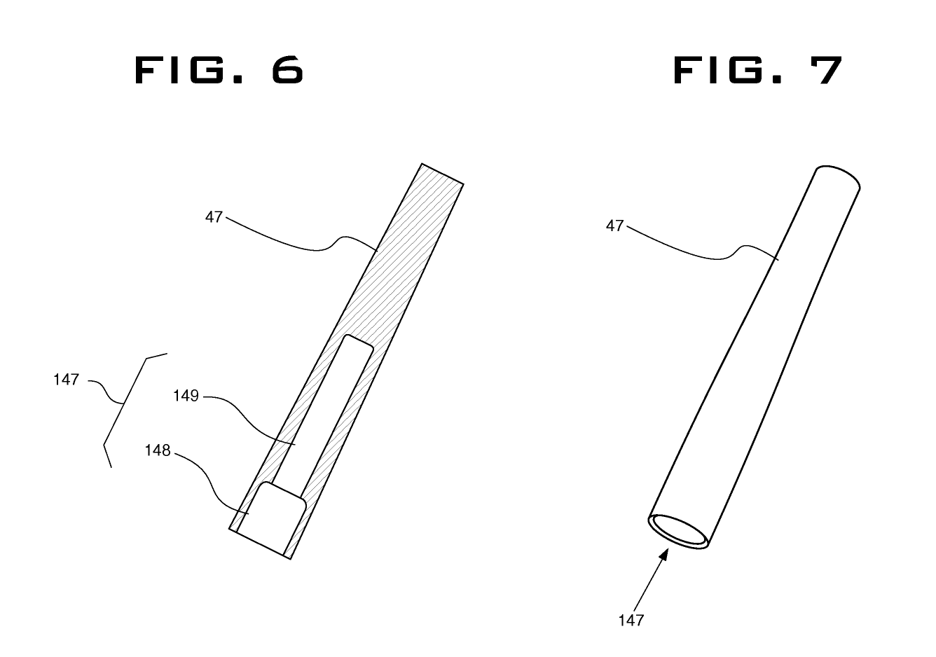

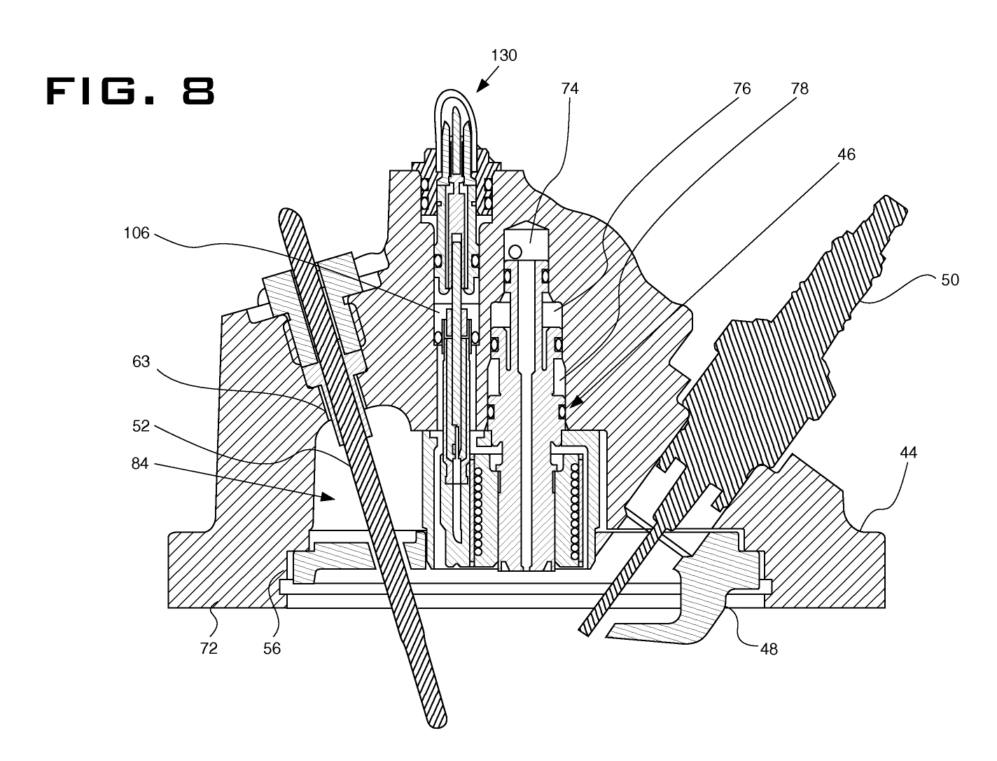

Referring to FIGS. 2-7, end cap 47 is coupled to the ceramic end seal 135 and disposed surrounding the electrical contact pin 128. The end cap 47 may include an interior void 147 having a larger diameter lower void 148 corresponding to the ceramic end seal 135 and a smaller diameter upper void 149 corresponding to the electrical contact pin 128. In one embodiment, a first end of the end cap 47 disposed proximal to the ceramic end seal 135 has an outer diameter substantially equal to an outer diameter of the outer tube 137. The end cap 47 is tapered in a direction away from the ceramic end seal 135. Embodiments of the end cap 47 may include plastic and may be manufactured relatively cheaply, e.g., by injection molding. The end cap 47 may assist assembly and protection of the electrical contact member 104 as discussed in more detail below.

Heat shield 138 may substantially enclose heater 102 to reduce or minimize the amount of thermal energy convected and/or radiated to the air within air distribution passage 84 (referring to FIG. 3). That is, heat shield 138 may annularly surround the at least one heater coil 120 and be spaced apart from the at least one heater coil 120 such that an insulative air gap 140 is created with the heat shield 138. An annular portion of heat shield 138 may include a tapered and shouldered through hole 142 that accommodates the connection of the at least one heater coil 120 to the electrical contact pin 128. In one embodiment, the fluid injector unit 46, including fluid injector 100, heater 102 and heat shield 138, may be retained in place by the mixing plate 48.

Pressurized fuel may be directed into and around the fluid receiving end 108 of the fluid injector 100 toward the fluid injecting end 110 for injection, while coolant may be directed around the fluid receiving end 108 to prevent coking of fuel within the fluid injector 100. Between injection events, current may be selectively applied to heater 102 to evaporate and/or burn away any residual fuel or buildup within the fluid injecting end 110 of the fluid injector 100 (i.e., purge a fluid injecting end 110 of fluid injector unit 46). External surfaces of fluid injector unit 46 may also be purged of deposits and fuel, thereby maintaining spray angle and quality. Heat shield 138 may reduce or minimize the amount of heat convected and/or radiated away from heater 102 during the purge process.

The fluid injector unit 46 may also optionally include a thermal ground 106 disposed about a distal end of the electrical contact member 104 from the heater 102. The thermal ground 106 is disposed between the sealing member 134 and housing 44 when the fluid injector unit 46 is assembled into centrally located bore 60. In one embodiment, the thermal ground 106 may be formed in-place as a thermally conductive epoxy. Specifically, the thermal ground 106 may be an adhesive based, room-temperature curing compound injected in a radial gap between the end of the electrical contact member 104 distal to the heater 102 and the housing 44. However, alternative embodiments include configurations wherein the thermal ground 106 may be formed via various mechanisms or omitted altogether.

In one embodiment, the thermal ground 106 is disposed in contact with the housing 44 and only the sealing member 134 of the electrical contact member 104. The thermal ground 106 may be disposed axially surrounding the ceramic end seal 135. In such an embodiment, the ceramic end seal 135 may be exposed to contact a portion of the female-type receptacle 130 in order to form a fluid-tight seal. In the illustrated embodiment, the thermal ground 106 is disposed in contact with an O-ring seal 144 that prevents fluids from traveling axially along the centrally located bore 60. The thermal ground 106 helps to extend the life of the elastomeric end seal 136 and the O-ring seal 144 as will be discussed in more detail below.

### INDUSTRIAL APPLICABILITY

The fluid injector unit 46 of the present disclosure may be applicable to a variety of exhaust treatment devices 40 including, for example, particulate traps requiring periodic regeneration, catalytic converters requiring a predetermined temperature for optimal operation, SCR devices requiring the injection of ammonia or another catalyst, and other similar devices known in the art. In fact, the disclosed fluid injector unit 46 may be implemented into any power unit 10 that benefits from clog-free injector operation. The operation of power unit 10 will now be explained.

Referring to FIG. 1, air and fuel may be drawn into combustion chambers 17 of power unit 10 for subsequent combustion. Specifically, fuel from fuel system 12 may be injected into combustion chambers 17 of power unit 10, mixed with the air therein, and combusted to produce a mechanical work output and an exhaust flow of hot gases. The exhaust flow may contain a complex mixture of exhaust products composed of gaseous and solid material, which can include particulate matter. As this particulate containing exhaust flow is directed from combustion chambers 17 through exhaust treatment device 40, particulate matter may be strained from the exhaust flow by filtration medium 42. Over time, the particulate matter may build up in filtration medium 42 and, if left unchecked, the buildup could be significant enough to restrict, or even block the flow of exhaust through exhaust treatment device 40. As indicated above, the restriction of exhaust flow from power unit 10 may increase the backpres sure of power unit 10 and reduce the unit's ability to draw in fresh air, resulting in decreased performance of power unit 10, increased exhaust temperatures, and poor fuel consumption.

To prevent the undesired buildup of particulate matter within exhaust treatment device 40, filtration medium 42 may be regenerated. Regeneration may be periodic or based on a triggering condition, such as, for example, an elapsed time of engine operation, a pressure differential measured across filtration medium 42, a temperature of the exhaust flowing from power unit 10, a radio frequency measurement of particulate matter density, or any other condition known in the art.

To initiate regeneration, fluid injector unit 46 may be caused to selectively pass fuel into exhaust treatment device 40 at a desired rate (i.e., an injection event). As a pilot injection of fuel from fluid injector unit 46 sprays into combustion canister 54, a spark from spark plug 50 may ignite the fuel. As a main injection of fuel from fluid injector unit 46 is passed into exhaust treatment device 40, the burning pilot flow of fuel may ignite the main flow of fuel. The ignited main flow of fuel may then raise the temperature of the particulate matter trapped within filtration medium 42 to the combustion level of the entrapped particulate matter, burning away the particulate matter and, thereby, regenerating filtration medium 42.

Between regeneration events (the regeneration events including injection events), fluid injector unit 46 may be selectively purged of fuel and any accumulated buildup (i.e., heat to evaporate or burn away fuel and/or accumulated buildup) to ensure proper operation thereof. The purge process may begin when a purge trigger is received or recognized by a controller. Purging may be triggered in a number of different ways. For example, purging may be triggered when a time elapsed since a previous purge event has exceeded a threshold time period. In some situations, this threshold time period may be in the range of 20-60 hours and, more specifically, about 25 hours. In another example, purging may be triggered after the successful completion of each regeneration event described above. In yet another example, purging may be triggered when a regeneration event has failed (i.e., when ignition of the injected fuel can not be confirmed, when a temperature of the particulate matter has failed to reach its combustion threshold temperature, and/or when too many losses of combustion during a regeneration event have occurred). It is contemplated that other purge triggers may also or alternatively be employed, if desired.

The next step after initiating the desired purge process may include determining what triggered the desired purge process. As described above, purge processes may be triggered in a number of different ways. If the trigger is the successful completion of a regeneration event, the desired purge process may include only the warming of fluid injector unit 46 to evaporate any fuel remaining within the fluid injecting end 110 of the fluid injector 100. If warming is desired, the appropriate waveform may be communicated to the heater 102 via the electrical contact member 104 such that the temperature of heater 102 reaches about 300° C. and is maintained for about 10-15 minutes.

However, if the trigger is an amount of time elapsed since a previous purge event or an abnormal pressure decay rate of fuel within fluid injector unit 46, a purge event requiring a higher temperature and/or heating duration may be desired. At this level of purging, the waveform directed to heater 102 may result in temperatures up to about 475° C. being maintained for a duration of about one hour.

If the trigger is a failed regeneration event, it may be concluded that fluid injector unit 46 may be at least partially clogged (i.e., failed injection event). In order to unclog fluid injector unit 46, the temperature and duration of heater 102 may be increased even further. At this level of purging, the waveform directed to heater 102 may result in temperatures that exceed 475° C. for more than one hour. It is contemplated that, after a failed regeneration event, purging in an attempt to unclog fluid injector unit 46 may be limited to a predetermined number of events. That is, if, for example, a regeneration event fails after just completing a high temperature and/or long duration purge, other precautionary measures may be taken such as warning an operator of power unit 10, shutting down power unit 10, and other such measures, if desired.

The fluid injector unit 46 functions in an environment with large temporal and spatial fluctuations in temperature. Specifically, temperatures near the at least one heater coil 120 may reach 200° C. to 250° C. This thermal energy may be conducted by the at least one heater coil 120 along the electrically conductive inner core 114 to the electrical contact pin 128, thereby raising temperatures of adjacent components, such as the sealing member 134 and the o-ring seal 144. If the electrically insulative layer 132 were to be exposed to hydrocarbons, carbon may build within the sleeve 126 and form a conduction path for the electrical contact pin 128 to ground. This conduction path would render the fluid injector unit 46 inoperative. This disclosure provides the electrical contact member 104 that includes the sealing member 134 which provides optimal sealing function even in a high temperature environment.

The sealing member 134 includes the ceramic end seal 135 in order to create a robust joint with inner tube 136 and outer tube 137. In an embodiment wherein the inner tube 136 and outer tube 137 are made from an austenitic nickel-chromium-based alloy, such as Inconell® from Special Metals Corporation, the inner tube 136 and outer tube 137 may exhibit relatively minor thermally induced expansion or contraction as compared to more conventional materials, e.g., steel or aluminum. The ceramic end seal 135 may exhibit a greater degree of elasticity than either the inner tube 136 or the outer tube 137, and thus may accommodate differential expansion between the inner tube 136 and the outer tube 137 while still maintaining a seal between the two. In addition, the ceramic end seal 135 may withstand comparatively high temperatures without degradation thereof as compared to conventional rubber based elastomeric sealing materials. The joint created by the ceramic end seal 135 and metal surfaces of the inner tube 136 and outer tube 137 is capable of withstanding high temperatures and differential temperatures within the sealing member 134 without causing excessive stresses that may lead to degradation of the seal.

The fluid injector unit 46 may also not function as desired if the electrical contact pin 128 does not make contact with the female-type receptacle 130 (See FIG. 8). As illustrated in FIGS. 2-7, the end cap 47 may be disposed on the sealing member 134 prior to assembly into the auxiliary regeneration system 14 and may prevent damage to the electrical contact pin 128 that would cause misalignment between the electrical contact pin 128 and the female-type receptacle 130. That is, in one embodiment, the end cap 47 is placed on the sealing member 134 at the time that the fluid injector unit 46 is manufactured. The end cap 47 may protect the electrical contact pin 128 and the sealing member 134 from being bent or otherwise harmed during movement of the fluid injector unit 46 due to the end cap 47 deflecting or absorbing incoming forces that would otherwise be applied to by the electrical contact pin 128 or the sealing member 134. In addition, the tapered shape of the end cap 47 may facilitate installation of the o-ring seal 144. That is, once the fluid injector unit 46 and end cap 47 are inserted into housing 44, the o-ring seal 144 may be inserted onto an end of the end cap 47 distal to the heater 102 and the end cap 47 may function as a mandrel to slowly expand the o-ring seal 144 into place surrounding the sleeve 126 due to the tapered shape of the end cap 47. The o-ring seal 144 has an inner diameter which varies as a function of restoring forces and expanding forces applied thereto and the end cap 47 is tapered such that a first end of the end cap has a first diameter corresponding to a minimum inner diameter of the o-ring seal 144 and such that a second end of the end cap 47 has a second diameter greater than the first diameter. Once the o-ring seal 144 is installed within housing 44, the end cap 47 may be removed to expose the electrical contact pin 128 (see FIG. 8).

Referring now to FIG. 8, this disclosure also provides a means for regulating a maximum temperature of, and controlling amplitude of temperature swings of, the sealing member 134 and the o-ring seal 144. Cycling of the heater 102 and conduction of that heat through the electrical contact member 104 may lead to aging of the o-ring seal 144, even if the maximum temperatures thereof are not exceeded. However, the thermal ground 106 provides a path for conduction of thermal energy away from the electrical contact member 104 and into the relatively cooler housing 44. That is, the thermal ground 106 allows the housing 44 to function as a heat sink for the electrical contact member 104. In some instances, the housing 44 at the location of the thermal ground 106 may be 145-155° C. while the heater 102 is 200-250° C. The housing 44 may be cooler at this location for several reasons. First, the housing 44 extends away from the exhaust passageway 35 and into relatively cooler ambient air. Second, the housing 44 may be cooled by fuel and coolant flowing through the main fuel chamber 76 and the coolant chamber 78 immediately adjacent to the electrical contact member 104. In one embodiment, at least a portion of the housing in contact with the thermal ground is cooled by fluid flow through at least one of the main fuel chamber 76 and the coolant chamber 78.

In the embodiment wherein the thermal ground 106 is formed-in-place, e.g., by curing a liquid thermally conductive epoxy, the thermal ground 106 provides a relatively large surface area contact between the sealing member 134 and the housing 44. That is, the thermal ground 106 may fill voids between the two components, thus increasing the total surface area for thermal energy transfer. In addition, in such an embodiment, the thermal ground 106 may act as an additional barrier to contaminant entry into the electrical contact member 104. The thermal ground 106 may be coupled to the o-ring seal 144 in such an embodiment due to the nature of the form-in-place deposition process.

The disclosed injector configuration may ensure continued and successful regeneration events by removing residual fuel and buildup therefrom in an efficient manner with reliable seal performance. Specifically, by heating a nozzle portion of the injector (i.e., that portion of fluid injector unit 46 spraying fuel into combustion canister 54), both residual liquids and solid buildup therein may be efficiently burned away. By removing both the liquids and the solids, the successful operation of the disclosed injector may be prolonged, as compared to a purge system that only removes a bulk of the liquids. The sealing member 134 is generally resistant to thermal deformation and may continue to provide excellent sealing characteristics even in the thermal environment of the auxiliary regeneration system 14. In addition, the thermal conduction away from the seals protecting the electrical connection components from contamination will increase seal life.

It will be apparent to those skilled in the art that various modifications and variations can be made to the fluid injector of the present disclosure without departing from the scope of the disclosure. Other embodiments will be apparent to those skilled in the art from consideration of the specification and practice of the injector disclosed herein. For example, although the disclosed injector is illustrated as drawing pressurized fuel from a fuel system, the disclosed injector may alternatively draw pressurized fuel from a separate dedicated source, if desired. Further, although general examples have illustrated the disclosed injector as being associated with fuel for particulate regeneration purposes, it is contemplated that fluid injector unit 46 may just as easily be used to inject ammonia, AdBlue, and/or urea within a Selective Catalytic Reduction (SCR) device, if desired. In addition, it is contemplated that the disclosed heater and control system may be combined with an air- or chemical-purging system to more effectively remove liquid fuel and/or residue from the disclosed injector, if desired. It is intended that the specification and examples be considered as exemplary only, with a true scope of the disclosure being indicated by the following claims and their equivalents.

What is claimed is:

1. A fluid injector unit for use in an exhaust treatment system, comprising:
a fluid injector having a fluid receiving end and a fluid injecting end;
a heater disposed about the fluid injecting end of the fluid injector; and
an electrical contact member electrically connected to the heater, wherein the electrical contact member includes:
an electrical contact pin electrically coupled to the heater; and
a ceramic end seal axially surrounding the electrical contact pin.

2. The fluid injector unit of claim 1, wherein the electrical contact member further includes:
an inner tube disposed between the electrical contact pin and the ceramic end seal; and
an outer tube axially surrounding the ceramic end seal.

3. The fluid injector unit of claim 2, wherein the inner tube and the outer tube are constructed from an austenitic nickel-chromium-based alloy.

4. The fluid injector unit of claim 2, wherein the heater includes coaxial wiring, the coaxial wiring including a conductive inner core electrically coupled to the electrical contact pin, an electrically insulating sheath surrounding the conductive inner core and a conductive outer sheath surrounding the electrically insulating sheath.

5. The fluid injector unit of claim 4, wherein the electrical contact member includes:
a sleeve coupled to the conductive outer sheath of the coaxial wiring and axially surrounding the electrical contact pin; and
an insulative layer disposed between the sleeve and the electrical contact pin,
wherein the outer tube is coupled to a distal end of the sleeve.

6. The fluid injector unit of claim 5, wherein the outer tube and the sleeve are laser welded together.

7. The fluid injector unit of claim 1, further comprising a thermal ground axially surrounding the ceramic end seal.

8. The fluid injector unit of claim 7, wherein the thermal ground is a thermally conductive epoxy.

9. The fluid injector unit of claim 1, further including an end cap coupled to the ceramic end seal and surrounding the electrical contact pin.

10. The fluid injector unit of claim 9, wherein the end cap is tapered in a direction away from the ceramic end seal.

11. The fluid injector unit of claim 10, wherein the electrical contact member further includes:
an inner tube disposed between the electrical contact pin and the ceramic end seal; and
an outer tube substantially surrounding the ceramic end seal, and
wherein a first end of the end cap has an outer diameter substantially equal to an outer diameter of the outer tube.

12. The fluid injector of claim 1, wherein a fluid received and injected by the fluid injector is diesel fuel.

13. A regeneration system comprising:
a housing; and
a fluid injector unit disposed in the housing, the fluid injector unit including:
a fluid injector having a fluid receiving end and a fluid injecting end;
a heater disposed about the fluid injecting end of the fluid injector; and
an electrical contact member electrically connected to the heater, wherein the electrical contact member includes:
an electrical contact pin electrically coupled to the heater; and
a ceramic end seal disposed axially surrounding the electrical contact pin.

14. The exhaust aftertreatment auxiliary regeneration system of claim 13, wherein the electrical contact member further includes:
an inner tube disposed between the electrical contact pin and the ceramic end seal; and
an outer tube surrounding the ceramic end seal.

15. The exhaust aftertreatment auxiliary regeneration system of claim 14, wherein the inner tube is coupled to the ceramic end seal by a first ceramic to metal braze, and wherein the outer tube is coupled to the ceramic end seal by a second ceramic to metal braze.

16. The exhaust aftertreatment auxiliary regeneration system of claim 14, wherein the heater includes coaxial wiring including a conductive inner core electrically coupled to the electrical contact pin, an electrically insulating sheath surrounding the conductive inner core and a conductive outer sheath surrounding the electrically insulating sheath.

17. The exhaust aftertreatment auxiliary regeneration system of claim 16, wherein the electrical contact member includes:
a sleeve coupled to the conductive outer sheath of the heater and axially surrounding the electrical contact pin; and
an insulative layer disposed between the sleeve and the electrical contact pin,
wherein the outer tube is coupled to a distal end of the sleeve at.

18. The exhaust aftertreatment auxiliary regeneration system of claim 13, further including an end cap coupled to the ceramic end seal, the end cap substantially surrounding the electrical contact pin.

19. The exhaust aftertreatment auxiliary regeneration system of claim 18, wherein the end cap is tapered in a direction away from the ceramic end seal.

20. The exhaust aftertreatment auxiliary regeneration system of claim 19, further comprising an O-ring seal coupled to a thermal ground and axially surrounding a portion of the electrical contact member distal to the heater,
wherein an elasticity of the O-ring seal is predetermined such that an inner diameter of the O-ring seal may exceed an outer diameter of the end cap along an entire length of the end cap.

21. A regeneration system comprising:
a housing; and
a fluid injector unit disposed in the housing, the fluid injector unit including:
a fluid injector having a fluid receiving end and a fluid injecting end;
a heater disposed about the fluid injecting end of the fluid injector;
an electrical contact member electrically connected to the heater, wherein the electrical contact member includes:
an electrical contact pin electrically coupled to the heater; and
a ceramic end seal disposed axially surrounding the electrical contact pin;
an elastomeric sealing member disposed between the electrical contact member and the housing, the elastomeric sealing member having an inner diameter which varies as a function of restoring forces and expanding forces applied thereto; and
an end cap substantially surrounding the electrical contact pin,
wherein the end cap is tapered such that a first end of the end cap has a first diameter corresponding to a minimum inner diameter of the elastomeric sealing member and such that a second end of the end cap has a second diameter greater than the first diameter.
